(19) United States
(12) Patent Application Publication
(10) Pub. No.: US 2008/0277330 A1
(43) Pub. Date: Nov. 13, 2008

(54) Device and Method For Thermally Drying Filter Cakes in Diaphragm-Filter Presses

(75) Inventors: Ulrich Esser, Kurten (DE); Dieter Mrotzek, Burscheid (DE); Jurgen Sebastian, Westhofen (DE)

Correspondence Address: NORRIS, MCLAUGHLIN & MARCUS, P.A., 875 THIRD AVE, 18TH FLOOR, NEW YORK, NY, 10022, US

(73) Assignee: BAYER TECHNOLOGY SERVICES GMBH, LEVERKUSEN (DE)

(21) Appl. No.: 11/816,503

(22) PCT Filed: Feb. 14, 2006
(86) PCT No.: PCT/EP2006/001323

§ 371 Date: May 8, 2008

(30) Foreign Application Priority Data
Feb. 25, 2005 (DE) 10 2005 008 664.0

(51) Int. Cl. B01D 35/18; B01D 35/00

(52) U.S. Cl. 210/225; 210/231

(57) ABSTRACT

Heatable filter plate comprising two interconnected corrugated elements forming a cavity for the flow of a temperature controlled medium, filter press comprising said filter plate and diaphragm-filter plates in an alternating manner, and method for drying filter cakes in said filter press.

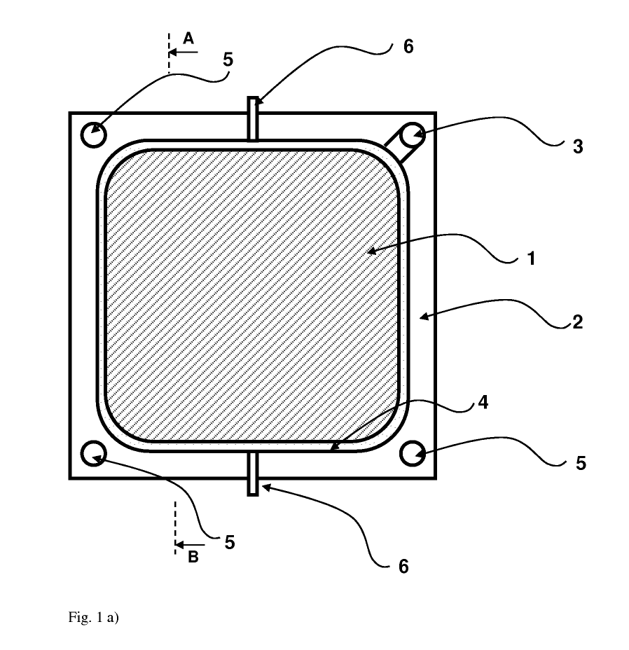

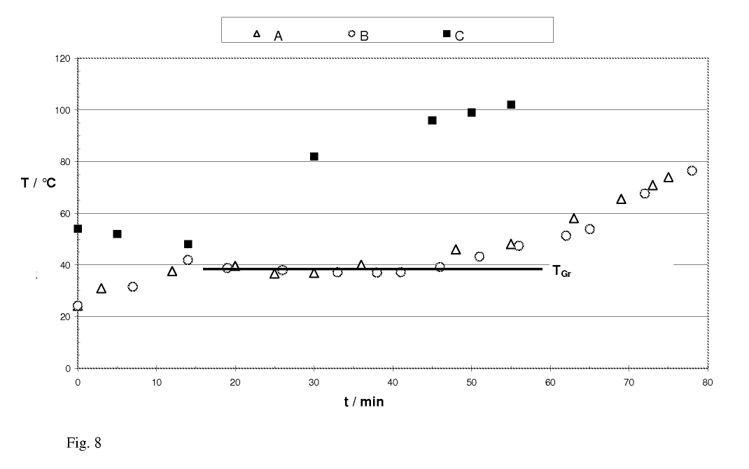

The invention relates to a heatable chamber filter plate (FIGS. 1-4) or pressure/wash plate with associated frame, a filter press (FIGS. 9-11) made up from said chamber filter plate and diaphragm chamber filter plates in alternation, and a method of thermally drying filtercakes in said diaphragm chamber filter press or diaphragm filter press.

A filter press consists of a plurality of chamber plates or pressure/wash plates arranged in parallel, together with associated frame. The chamber plates have recesses so that when any two plates are joined, chambers are formed which are utilized as filtration spaces with the aid of filter media (for example cloths). In the case of the press/wash plates, when filter media such as paper or depth filters, for example, are used, a filtration space becomes accessible by means of the associated frame. During the filtration, the chamber plates or the pressure/wash plates with associated frame are pressed together mechanically or hydraulically in the frame region in order to seal the filtration spaces. The surfaces of the plates, except for the frame region, can be structured in order to enable outflow of the filtrate.

For separating off solids from suspensions, use is made of filter presses from the laboratory to the process scale. In this case it is of interest to obtain, in the shortest possible time, the largest possible amounts of solids as dry as possible and/or the largest possible amounts of purified liquid.

In a diaphragm filter press, therefore, in a first step a filtration is carried out in which the filtercake is formed, which can be followed by a wash step and/or a mechanical pressing step. In the mechanical pressing step, the filtercake, with the aid of a diaphragm attached to the diaphragm chamber plate, behind which diaphragm a pressing pressure is built up, is pressed and consolidated, in order to minimize the liquid which is still situated in the filtercake.

The mechanical pressing step can be followed by a temperature-controlled drying, in which the thermal pre-settings are introduced via the pressurizing medium into the diaphragm chamber plates and/or via chamber plates or pressure/wash plates equipped with heating and cooling elements, which are then arranged in alternation with the diaphragm chamber plates in the plate package. In addition, the filter chambers can be evacuated via the filtrate outflow channels.

EP 0 676 225 A and GB 2 258 621 A disclose filter plates for chamber filter presses which allow the method described to be carried out in principle. EP 0 676 225 A describes a simple heatable filter plate and GB 2 258 621 A a diaphragm filter plate which is heatable by the pressurizing medium. However, it is found in practice that the residual moisture of the filtercake achievable with a predetermined expenditure of energy and time is still relatively high. As a result, in addition a separate drying method is required in order to achieve the necessary dry matter content of the filtercake.

EP 1 088 580 B1 discloses smooth or surface-profiled heatable chamber plates, preferably in a metallic construction, which, in alternation with diaphragm chamber filter plates, form a plate package. These heating plates are preferably constructed as a rigid wall, so that in a chamber, filtrate can only flow out over the surface which is formed by the diaphragm chamber plate, and as wash step, washing can only be carried out via the channel delivering the suspension. The heat transfer to suspension or filtercake is likewise restricted by the construction as a rigid wall. In addition, the solids discharge is difficult, since filtercakes, despite a disclosed coating, exhibit the tendency of adhering to the metallic heating wall.

CH 341798 A describes a weight-reduced filter plate having a plate rim of rods of a U-shaped profile which are connected to a plate body consisting of corrugated sheet metal. Otherwise, no further function is ascribed to the described plate body.

Therefore, proceeding from the known prior art, the object is to provide a filter plate, the surface and construction of which make possible particularly good temperature transfer to suspension and filtercake, the surface of which makes possible simple filtrate removal and thereby also washing of the filtercake via the channels removing the filtrate, the surface and other equipment of which permit simple and complete solids discharge of the filtercake and is simple and inexpensive to fabricate. A diaphragm chamber filter press available therefrom and use thereof in a filtration method is intended to greatly reduce the filtration and drying times and to minimize the temperature-controlling power required.

The invention therefore relates to a temperature-controllable chamber filter plate or pressure/wash plate with associated frame with a heating and cooling body, characterized in that, as heating and cooling body, use is made of at least two interconnected corrugated elements which form at least one cavity and through which a temperature-controllable medium flows.

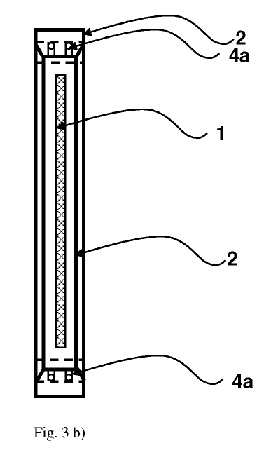

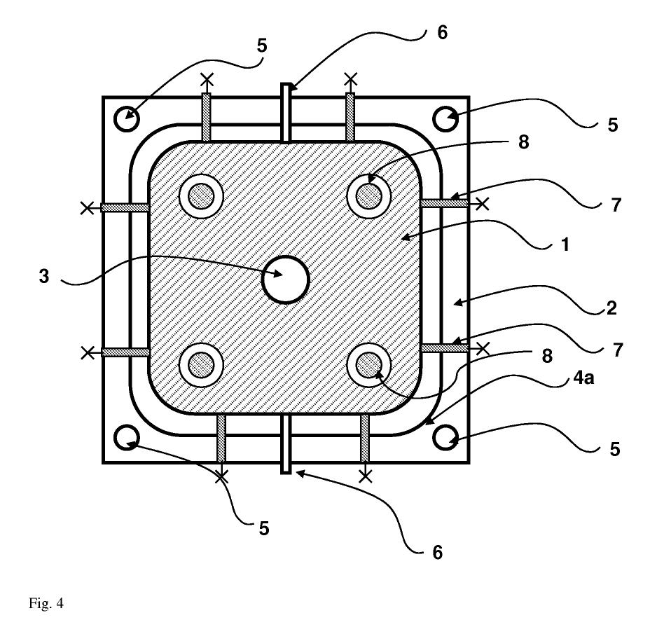

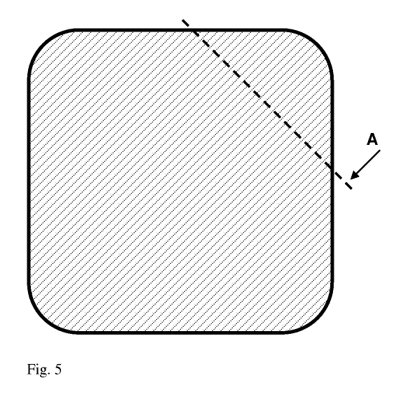

The heating and cooling body in the chamber filter plate or pressure/wash plate with associated frame according to the invention preferably comprises a good heat-conducting material which is chemically inert and enables good temperature transfers to the suspension to be filtered or the filtercake to be dried, preferably made of metal, heat-conducting polymers, which can be fabric-, fiber- or filler-reinforced and/or made of a combination material of metal and heat-conducting polymers, particularly preferably of aluminum or corrosion-resistant stainless steel, very particularly preferably made of corrosion-resistant stainless steel. To maintain filtrate outflow, the surfaces of the heating and cooling body facing the filtercake chambers are structured. This structuring preferably consists of corrugations, so that, as body bounding the filtercake chamber, use can be made of a simple corrugated metal sheet (FIG. 5). The latter construction has the advantage that by connecting at least two (FIG. 6, FIG. 7) of such corrugated metal sheets, with the corrugations being arranged offset, preferably by an angle between 10 and 170° or 190 and 350°, particularly preferably by an angle of 45 to 135° or 225 to 315°, particularly preferably by 90° or 270°, a cavity is formed in which the flow of the temperature-controlling medium is continuously deflected by the set angle. In this case, when more than two corrugated metal sheets are used, the profiles can be arranged offset by in each case the same or different angles, preferably by the same angle, particularly preferably in each case by 90° or 270°. By this simple arrangement of the inexpensive metal sheets, surprisingly good temperature transfer from temperature-controlling medium to heating and cooling body results and thereby to the suspension and/or filtercake, so that the circulation rate of temperature-controlling medium can be set at a minimum and the drying times reduced.

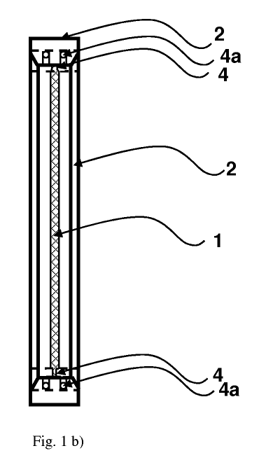

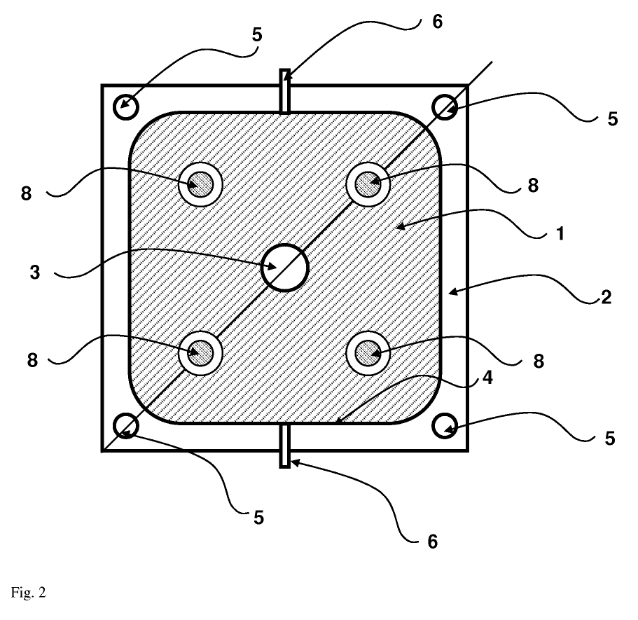

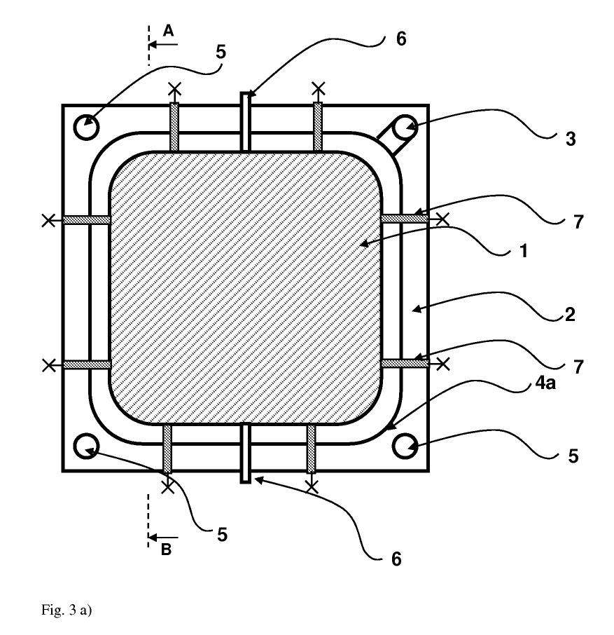

The chamber filter plate or pressure/wash plate with associated frame of the invention contains the heating and cooling body of the invention which is connected to a frame in a positive-fit manner (FIGS. 1, 2) or a non-positive-fit manner (FIGS. 3, 4). The frame can be fabricated from any desired material, from metal, plastic or a combination material, in a preferred embodiment from plastic, in a particularly preferred embodiment from poly(vinylidene fluoride) or polypropylene, in a very particularly preferred embodiment from polypropylene.

In the positive-fit design, the filtrate outflow can be ensured via a recess in the corrugation element, that is an outflow channel, for example, which runs around the outer rim of the heating and cooling body on both sides and is connected via boreholes to the filtrate outflow channels (FIGS. 1a), b)). It is likewise conceivable, in the frame at the contact surfaces with the corrugation elements, to construct outflow channels on both sides which themselves are reunited with the filtrate outflow channels (FIG. 2). In a further embodiment it is conceivable to connect one dimensionally adapted, that is to say size-reduced, heating and cooling body each to two perforated sheets mounted in the frame, which sheets form an inner space for filtrate removal.

In a preferred embodiment, the heating and cooling body is connected to the frame in a non-positive-fit manner via, for example, webs or bolts. This arrangement offers the advantage that heat bridges to the exterior can be minimized, so that higher or lower temperature-controlled medium temperatures are possible than those predetermined by the choice of the plastics (frame and diaphragm chamber filter plate adjacent to the frame region). For instance, in this example, which illustrates the invention without restricting it thereto, in a combination of a chamber filter plate according to the invention made of metallic heating and cooling body with metallic frame with polypropylene diaphragm chamber filter plate, heating medium temperatures of >100° C. can be selected without the diaphragm chamber filter plate being stressed at temperatures of, for example, >80° C.

The chamber filter plate is equipped according to the invention on both sides with filter media, for example with an overhanging filter cloth or, in a drip-tight and vacuum-tight design, with two individual filter cloths which are fixed on both sides in the appropriately fitted frame of the chamber filter plate, preferably in a groove. When an overhanging cloth is selected, to improve the vacuum, the region of the sealing surfaces can be rubberized. The pressure/wash plate with associated frame is likewise according to the invention equipped on both sides with filter media, for instance with filter cloths, paper filters and/or depth filters, for example, which are fixed in an overhanging manner or in the appropriately equipped frame of the pressure/wash plate, preferably in a groove.

In a preferred embodiment, the frames are provided with a vacuum-tight rim seal, with an integrated filter media clamp being provided within the rim seal on both sides, preferably in a groove.

In the production obvious to those skilled in the art of said chamber filter plates or pressure/wash plates with associated frame, the abovementioned parts are glued to one another, welded or, with additional use of seals, screwed together, the temperature-controllable body is produced in such a manner that the corrugated metal sheets are connected to one another, for instance by gluing, stapling, riveting, screwing or by thermal methods, for example soldering and/or welding, or else the body is cast; in a preferred embodiment the corrugated metal sheets are soldered or welded, in a particularly preferred embodiment, welded.

The invention likewise relates to a filter press made up of the claimed chamber filter plates or the claimed pressure/wash plates with associated frame arranged in alternation with diaphragm chamber filter plates. The chamber filter plates or the pressure/wash plates with associated frame consist in this case, in a preferred embodiment, of metallic materials and of metallic heating and cooling body as core with frame of polymeric materials or polymeric composite materials, preferably of polypropylene or poly(vinylidene fluoride), particularly preferably polypropylene, while the diaphragm chamber filter plates can consist of purely polymeric materials or composite materials.

The filter press, in a preferred embodiment, consists of a plurality of chamber filter plates or pressure/wash plates with associated frame according to the invention arranged in alternation with a plurality of diaphragm chamber filter elements provided with a support wall which are clamped together at the rim so as to be drip-tight and vacuum-tight and for this have a plate frame adjoining the support wall, wherein the chamber filter plates or the pressure/wash plates with associated frame according to the invention, between themselves and the diaphragm chamber filter plates, form filter chambers having inlets for the suspension to be filtered opening therein. The filter-chamber-facing wall surface of the claimed chamber filter plate or pressure/wash plates with associated frame, by means of the corrugated profile coated with a filter medium, forms a conjugate system connected to the channels removing the filtrate. The diaphragm chamber filter plates, on one or both sides, preferably on both sides, bear a diaphragm which is tightly connected to the support wall or the plate frame by the rim and moreover can be advanced by a temperature-controllable pressure medium into the filter chamber, which diaphragm, on its wall surface facing the respective filter chamber, has profile projections coated with a filter medium which, below the filter medium fastened to the support wall or the plate frame, likewise form a conjugate system for the filtrate connected to the channels removing the filtrate.

The filter press according to the invention having the chamber filter plates or pressure/wash plates with associated frame according to the invention offers the advantage that the filtercake can be formed on both sides of the chamber filter plates or the pressure/wash plates, since the chamber filter plate or the pressure/wash plate, as mentioned, is equipped according to the invention on both sides with filter media and therefore twice the filter area can be used for filtration compared with the design according to EP 1 088 580 B1 with the same number of chambers. For the same final cake heights, the filtration time can therefore be reduced, preferably to 15 to 50% of the filtration time according to EP 1 088 580 B1, particularly preferably to 20 to 40% of the filtration time, very particularly preferably to approximately 25%.

As a result of the profiling of the surface of the heating and cooling element of the chamber filter plate or pressure/wash plate and on account of the filter medium present on both sides of the chamber filter plate or pressure/wash plate, there is additionally the advantage that complete discharge of the dried filtercake from the press can be ensured in a simple manner.

The method for drying filtercakes using the filter press according to the invention is likewise subject matter of the invention. A preferred method comprises introducing the suspension into the filter press, the filtration process, at least one mechanical pressing of the filtercake by a diaphragm of the diaphragm filter plate for discharge of the residual liquid, drying the filtercake by temperature-control by means of the chamber filter plate or pressure/wash plate according to the invention and/or the temperature-controllable pressure medium in the diaphragm filter plate and/or by evacuation of the filter chamber via the channels introducing the suspension and/or removing the filtrate. Between filtration phase and pressing phase, at least one washing can proceed via the channel introducing the suspension and/or via the channel removing the filtrate. However, washings can also proceed after the first pressing step. In the context of this method, owing to the properties of the claimed chamber filter plates or pressure/wash plates with associated frame, in the claimed filter press, washing via the suspension channel is possible at chamber fillings below 100%. Compared with the design according to EP 1 088 580 B1, the corrugated structure of the heating and cooling body gives the advantage that in addition filtrate channel washing can be carried out from the filtrate outflow side of the chamber plate toward the filtrate outflow side of the diaphragm chamber plate, or vice versa, as is possible with conventional diaphragm filter presses, since in addition even after the filtration step the filter cake can be consolidated via a pressing step.

It can prove advantageous that the filtercake remains under the post-pressuring pressure of the diaphragm during drying. As a result the filtercake is stabilized in the filter chamber and the volume shrinkage due to the liquid removal is compensated, so that collapse of the filtercake or crack formation is avoided.

In the drying step of the method according to the invention, it is of importance for the required temperature to be achieved in the filtercake as rapidly as possible. In the case of thermal drying, this can be achieved by selection of a high temperature-controlling medium temperature and/or a good heat transfer and/or a low evaporation temperature (low applied pressure), and in the case of efficient cooling, by the choice of a low temperature-controlling medium temperature and/or a good temperature transfer and/or a low evaporation temperature.

In one embodiment of the method according to the invention, a single temperature-control and pressure circuit can be used for temperature-control of the chamber filter plate or pressure/wash plate with associated frame according to the invention and for temperature-controlling the diaphragm chamber filter plate and for carrying out the pressing step by the diaphragm chamber filter plate (FIG. 9).

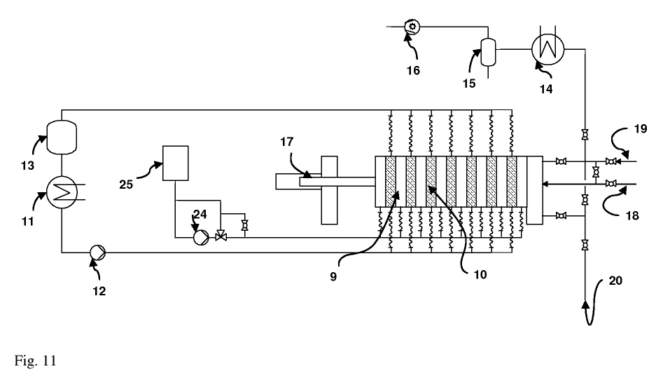

In a further embodiment of the method according to the invention, a temperature-control circuit can be established for temperature-control of the chamber filter plate or pressure/wash plate with associated frame according to the invention and a simple pressing medium connection for carrying out the pressing step by the diaphragm chamber filter plate. The temperature here is achieved only via the chamber filter plates or pressure/wash plates with associated frame (FIG. 11). The advantage of this embodiment is to be able to retrofit existing filter presses readily according to this embodiment.

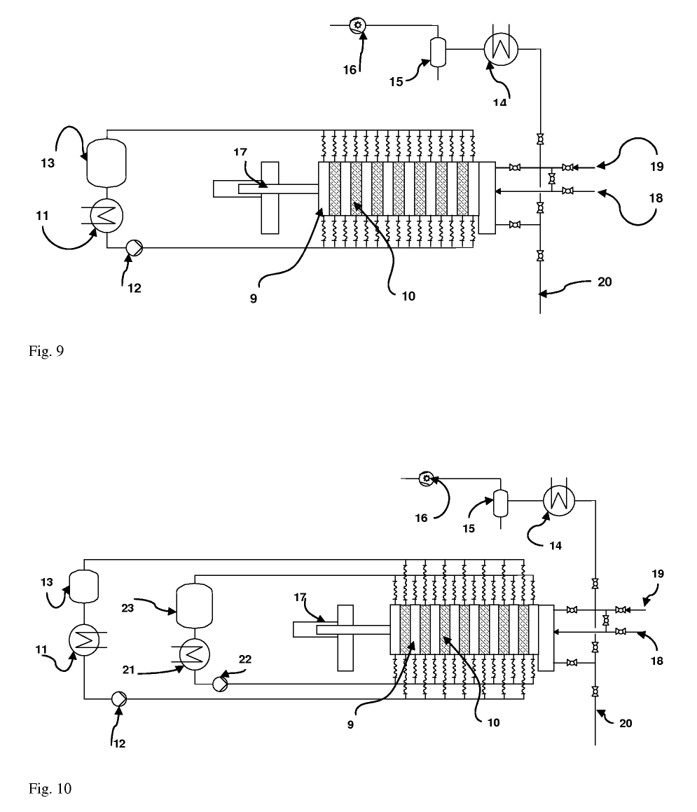

In a preferred embodiment, by installation of two temperature-control circuits in the method according to the invention the temperature-controlling medium temperatures of a chamber filter plate or pressure/wash plate with associated frame equipped with metallic heating and cooling body, and of the pressure medium of the diaphragm chamber filter plate can be set independently of one another (FIG. 10). This in turn has the advantage that even at the start of the pressing step before the drying step, the chamber filter plates or pressure/wash plates can be temperature-controlled, for instance heated or rapidly cooled, for example, without the diaphragm pressure needing to be reduced, which is a particularly preferred embodiment of the method according to the invention.

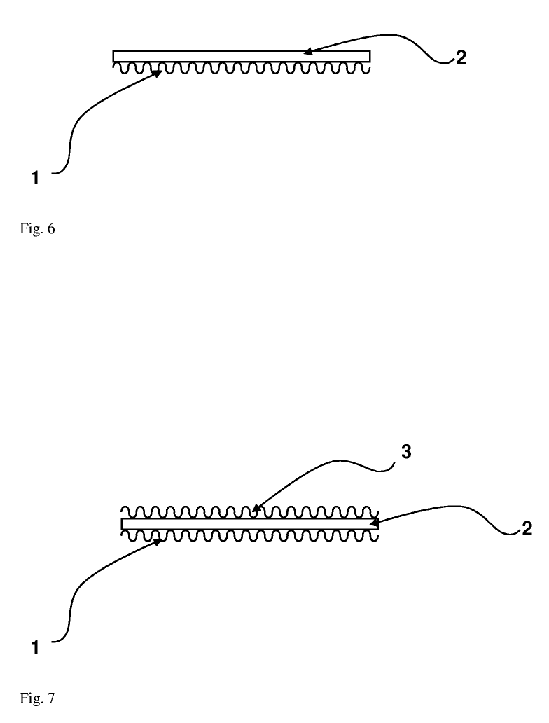

By this means the time required for a thermal drying step can again be significantly reduced. Experiments show, for example in the case of an inorganic solid, by application of the vacuum the first drying section, by measurement of a constant temperature of the filtercake (cooling limiting temperature) is already completed after ending the pressing and starting the drying step and is therefore no longer visible (FIG. 8).

Products, that is to say not only solids but also filtrates which are available via the method according to the invention, are likewise subject matter of the invention.

The chamber filter plate and pressure/wash plate with associated frame according to the invention, a filter press fabricated therefrom and the processing drying of filtercakes with the aid of the filter press of the invention offer the advantages that by filtrate removal via both surfaces of the chamber formed by the chamber filter plate or the pressure/wash plate with associated frame according to the invention and a diaphragm chamber plate, filtration times and times for a suspension channel washing are minimized, that, as a result of the corrugated structure of the chamber filter plate or pressure/wash plate and the possibility for consolidating the filtercake by pressing, the processing possibility of washing and evacuation via the channel, introducing the suspension and removing the filtrate is provided, and that on account of the special construction of the chamber filter plate or pressure/wash plate according to the invention, the heat transfer is optimized and times for drying are minimized, and also the double-sided arrangement of the filter media improves the solids discharge, and in particular no solid remains adhering in the chamber.

The chamber filter plates or pressure/wash plates with associated frame according to the invention and filter presses are suitable, in particular, for working up suspensions for obtaining and/or separating off the solid and/or the filtrate from chemical synthesis, from wastewaters and/or sewage sludges, from sand, gravel and/or building sludges, from ore, coal, mining or rock sludges in the mining sector, or for use in methods for producing cosmetics, pharmaceutical and/or medical products and foods for humans and/or animals.

The invention will be described in more detail hereinafter by way of example with reference to the figures, without, however, restricting it to this.

TABLE 1

| | Experiment A | Experiment B | Experiment C |
|---|---|---|---|
| Heating medium temperature | 100° C. | 100° C. | 100° C. |
| Metal chamber plate | | | |
| Heating medium temperature | 80° C. | 60° C. | 60° C. |
| PP-diaphragm chamber plate | | | |
| Start of heating | after pressing | after pressing | at start of pressing |
| Metal chamber plate | | | |
| Absolute pressure | 40 mbar | 40 mbar | 40 mbar |
| (at vacuum pump) | | | |
| Start of heating | after pressing | after pressing | after pressing |
| PP-diaphragm chamber plate | | | |
| Cooling limiting temperature | approximately 38° C. | approximately 38° C. | not achieved owing |
| | | | to heating during |
| | | | pressing |

In the drawings:

FIG. 1 a) shows a chamber filter plate having positive-fit heating plate and corner inlet with theoretical section along A and B.

FIG. 1 b) shows the theoretical plane of the section through the chamber filter plate shown in FIG. 1 a)

FIG. 2 shows a chamber filter plate having positive-fit heating plate and central inlet

FIG. 3 a) shows a chamber filter plate having non-positive-fit heating plate and corner inlet with theoretical section along A and B

FIG. 3 b) shows the theoretical plane of the section through the chamber filter plate shown in FIG. 3 a)

FIG. 4 shows a chamber filter plate having non-positive-fit heating plate and central inlet

FIG. 5 shows a heating plate with theoretical section

FIG. 6 shows the theoretical plane of the section of a heating plate as shown in FIG. 5

FIG. 7 shows the theoretical plane of the section of a heating plate as shown in FIG. 5

FIG. 8 shows the change in temperature of the filtercake with drying time

FIG. 9 shows the flowchart of a diaphragm chamber filter press and diaphragm frame filter press having a heating and pressure circuit

FIG. 10 shows the flowchart of a diaphragm chamber filter press and diaphragm frame filter press having two heating and pressure circuits

FIG. 11 shows the flowchart of a diaphragm chamber filter press and diaphragm frame filter press having a heating circuit for the chamber filter plates and a pressing water connection for the diaphragm filter plates

Tab. 1 shows the values plotted graphically in FIG. 8 in tabular form.

### EXAMPLES

FIG. 1 a) shows the view of a chamber filter plate according to the invention constructed with positive-fit temperature-controlling plate 1 of metal in a metal/plastic frame 2. The suspension to be introduced is passed into the filtration chamber via the corner inlet 3 and the filtrate is removed via the circulating filtrate outlet groove 4 which is implemented as a recess in the corrugated elements, which filtrate outlet groove is connected via boreholes 4a to the filtrate outlet channels 5. The temperature-controlling medium is fed and removed via the tube nipples 6. A hypothetical section along the dashed line is drawn. The following figure shows the imaginary plane of the section of the chamber filter plate from the point of view of the arrows A and B.

FIG. 1 b) shows the plan view of the imaginary plane of the section of a chamber filter plate as described in FIG. 1 a). The temperature-controlling plate 1 in the frame 2 is equipped on both sides and surrounding it with an outlet groove 4 which is connected via boreholes 4a to the filtrate outlet channels 5.

FIG. 2 shows the view of a chamber filter plate according to the invention constructed with positive-fit temperature-controlling plate 1 of metal in a metal/plastic frame 2. The suspension to be introduced is passed into the filtration chamber via the central inlet 3 and the filtrate is removed via the circulating outlet groove 4 implemented in the frame 2 at the contact surface with the corrugated elements, which outlet conjugate 4 is connected via boreholes 4a to the filtrate outlet channels 5. The temperature-controlling medium is fed and removed via the tube nipples 6. The support lugs 8 stabilize the filtration chamber.

FIG. 3 a) shows the view of a chamber filter plate according to the invention constructed with non-positive-fit temperature-controlling plate 1 of metal in a metal/plastic frame 2. The suspension to be introduced is passed into the filtration chamber via the corner inlet 3 and the filtrate removed via the boreholes 4a which connect the intermediate space between frame 2 and temperature-controlling plate 1 to the filtrate outlet channels 5. The temperature-controlling medium is fed and removed via the tube nipples 6. The temperature-controlling plate 1 and the frame 2 are connected to one another via webs and/or bolts 7. A notional section along the dashed line is drawn in. The following figure shows the imaginary plane of the section of the chamber filter plate from the point of view of arrows A and B.

FIG. 3 b) shows the view of the imaginary plane of the section of a chamber filter plate as described in FIG. 3 a). The frame 2 is equipped with boreholes 4a which connect the intermediate space between frame 2 and temperature-controlling plate 1 to the filtrate outlet channels 5.

FIG. 4 shows the view of a chamber filter plate according to the invention constructed with non-positive-fit temperature-controlling plate 1 of metal in a metal/plastic frame 2. The suspension to be introduced is passed into the filtration chamber via the central inlet 3 and the filtrate is removed via the boreholes 4a which connect the intermediate space between frame 2 and temperature-controlling plate 1 to the filtrate outlet channels 5. The temperature-controlling medium is fed and removed via the tube nipples 6. The support lugs 8 stabilize the filtration chamber. The temperature-controlling plate 1 and frame 2 are connected to one another via webs and/or bolts 7.

FIG. 5 shows the view of a temperature-controlling plate without frame which is shown notionally sectioned along the dashed line. The figures below show the imaginary plane of the section of the temperature-controlling plate from the viewing direction of arrow A.

FIG. 6 shows the view of the imaginary plane of the section of a temperature-controlling plate as described in FIG. 5. The temperature-controlling plate consists of two corrugated metal sheets with are arranged offset to one another by 90°. The lower metal sheet 1 may be seen as a corrugated edge, while the upper metal sheet 2 shows the outermost corrugation in the side view. The metal sheets are connected to one another at the outer edges and at the points of contact by welding or soldering.

FIG. 7 shows the view of the imaginary plane of the section of a temperature-controlling plate as described in FIG. 5. The temperature-controlling plate consists of three corrugated metal sheets, which are arranged each offset to one another by 90°. The bottom and top metal sheets 1 and 3, respectively, may correspondingly be seen as a corrugated edge, while the center metal sheet 2 shows the outermost corrugation in the side view. The metals sheets are connected to one another at the outer edges and at the points of contact by welding or soldering.

FIG. 8 shows the change in temperature of the filtercake with drying time. In experiments A, B and C, an inorganic solid is filtered and dried by the method according to the invention in the chamber filter press of chamber filter plates according to the invention having metallic heating and cooling body and diaphragm chamber filter plates of polypropylene. The temperature-controlling medium temperature for the metallic heating and cooling body in all three experiments is 100° C. and that of the pressure medium for the diaphragm chamber plate in experiment A is 80° C., in experiments B and C actually only 60° C. In all three experiments, a reduced pressure of 40 mbar, measured at the vacuum pump, is applied. Solely in the case of experiment C is the heating and cooling body in the chamber filter plate already heated at the start of the pressing step, whereas in experiments A and B the start of heating does not start until after pressing. In all three experiments the pressure medium is not heated until after the pressing step. In experiments A and B, in the course of the first approximately 15 min a slow increase in filtercake temperature to approximately 38° C., the cooling limiting temperature, is observed, at which it remains at a standstill for approximately 40 min while residual filtrate evaporates from the filtercake, before in the course of a further 25 min increasing to approximately 80° C. In experiment C, owing to the start of heating at the start of the pressing step, a higher initial temperature of approximately 55° C. is observed, which in the course of the first 15 min slowly falls to approximately 45° C., in order then to increase to 80° C. in the course of the next 15 min and to achieve 100° C. after a further 20 min. A standstill at the cooling limiting temperature is not observed here.

FIG. 9 shows the flowchart of a diaphragm chamber filter press and diaphragm frame filter press having a heating and pressure circuit. Diaphragm chamber filter plates 9 and chamber filter plates or pressure/wash plates with associated frame 10 are arranged alternately in the stand 17. Via the connection 18, the diaphragm chamber filter press is filled with suspension. In the event of gap washing, the wash liquid is also applied via 18, and in the case of filtrate channel washing, this proceeds via connection 19. The filtrate is taken off via the filtrate outlet 20.

Diaphragm chamber filter plates 9 and chamber filter plates or pressure/wash plates with associated frame 10 form a heating/pressure circuit consisting of a receiver 13, a heat exchanger 11 and a transport and pressure pump 12. By means of this circuit, the filtercake can be pressed. During the drying phase, the circulating liquid is heated via 11. At the same time, the filtrate outlet 20 is closed and the inert materials are taken off via the vacuum pump 16 after condensation in the condenser 14 and separation in the separator 15.

FIG. 10 shows the flowchart of a diaphragm chamber filter press and diaphragm frame filter press having two heating and pressure circuits. In contrast to FIG. 9, diaphragm chamber filter plates and chamber filter plates or pressure/wash plates with associated frame have separate heating circuits (chamber filter plates or pressure/wash plates with associated frame 10, heat exchanger 11, pressure pump 12, receiver 13, and diaphragm chamber filter plates 9, heat exchanger 21, pressure pump 22, receiver 23). The advantage of this arrangement is that different temperatures can be set in the circuits. In addition, here the circuit can be connected via the chamber filter plates or the pressure/wash plates with associated frame even at the start of the pressing phase at high temperature.

FIG. 11 shows the flowchart of a diaphragm chamber filter press and diaphragm frame filter press having a heating circuit for the chamber filter plates and a pressing water connection for the diaphragm chamber filter plates. In contrast to FIG. 9 and FIG. 10, here the heat can only be introduced into the filter press for drying via the chamber filter plates or the pressure/wash plates with associated frame 10. Owing to the good conduction of heat into the chamber filter plates or the pressure/wash plates with associated frame 10, and the possibility of setting a higher temperature than is permissible for PP, for example, the drying phase, however, is not extended, or extended only slightly. A great advantage is that existing filter presses having a conventional pressing water system can be readily refitted with pressure pump 24 and receiver 25.

1. A temperature-controllable chamber filter plate or pressure/wash plate with associated frame with a heating and cooling body, comprising, as a heating and cooling body, at least two interconnected corrugated elements which form at least one cavity and through which a temperature-controllable medium is flowable.

2. The chamber filter plate or pressure/wash plate as claimed in claim 1, comprising filter media on both sides on the chamber filter plate or pressure/wash plate.

3. A diaphragm chamber filter press made up in alternation of diaphragm chamber filter plates and chamber filter plates and/or pressure/wash plates according to claim 1 with associated frame.

4. The diaphragm chamber filter press as claimed in claim 3, wherein the diaphragm chamber filter plates used are equipped on both sides with a diaphragm and/or filter medium.

5. A method of drying filtercakes which comprises drying said filtercakes in the diaphragm chamber filter press of claim 3.

6. The method of drying filtercakes of claim 5, wherein the chamber filter plate or pressure/wash plate is temperature-controlled at the start of the pressing step in the diaphragm chamber filter press.

7. The method as claimed in claim 5, wherein the chamber filter plate or pressure/wash plate comprises channels for introducing a suspension and/or for removing filtrate, and washings of the filtercake and/or evacuation of the filter chamber proceeds via said channel.

8. The method as claimed in claim 5, wherein the diaphragm chamber filter plates and chamber filter plates or pressure/wash plates with associated frame are operated each with a separate temperature-control/pressure circuit.

9. The method as claimed in claim 5, wherein the diaphragm chamber filter plates are operated with a pressing medium connection and the chamber filter plates or pressure/wash plates with associated frame are operated with a separate temperature-control/pressure circuit.

10. A product comprising a filter cake dried by the method of claim 5.

11. A diaphragm chamber filter press made up in alternation of diaphragm chamber filter plates and chamber filter plates and/or pressure/wash plates according to claim 2 with associated frame.

12. The diaphragm chamber filter press as claimed in claim 11, wherein the diaphragm chamber filter plates are equipped on both sides with a diaphragm and/or filter medium.

13. The method as claimed in claim 6, wherein the chamber filter plate or pressure/wash plate comprises channels for introducing a suspension and/or for removing filtrate, and washings of the filtercake and/or evacuation of the filter chamber proceeds via said channels.
